(19) United States
(12) Patent Application Publication
(10) Pub. No.: US 2026/0094167 A1
(43) Pub. Date: Apr. 2, 2026

(54) QR CODE BASED TECHNOLOGY PLATFORM FOR REAL-TIME ACCREDITATION OF CRITICAL RESOURCES

(71) Applicant: Commission on Accreditation for Prehospital Continuing Education, Dallas, TX (US)

(72) Inventors: Jay M. Scott, Lewisville, TX (US); Mark Sheldon, Lewisville, TX (US)

(21) Appl. No.: 18/899,523

(22) Filed: Sep. 27, 2024

(51) Int. Cl. G06Q 30/018; G06K 19/06

(52) U.S. Cl. CPC G06Q 30/018; G06K 19/06037

(57) ABSTRACT

A system, method and platform for generating and deploying real-time accreditation records for a resource. A disclosed method includes: transmitting a QR code to a provider of a certification event, wherein the QR code encodes an event ID of the certification event; receiving a completion token from an accreditation App, wherein the completion token includes resource details stored on the App and the event ID obtained by scanning the QR code; obtaining certification event details based on the event ID; generating a real-time record for the resource, wherein the real-time record includes the resource details and the certification event details; and uploading the real-time record to an accreditation database, wherein the real-time record is made immediately available for deployment to a resource certification system.

### TECHNICAL FIELD

The subject matter of this disclosure relates to a QR code technology platform that provides real-time accrediting of critical resources.

### BACKGROUND

There exist any number of domains in which critical resources must be certified as capable before they can be deployed. Critical resources may for example include equipment, machines, autonomous vehicles, systems, people, artificial intelligence models, etc., that perform functions that entail risk. One approach for mitigation of the risk is to implement an accreditation process to certify that the resource can effectively perform its role before it is deployed. Accreditation may for example include periodic testing, training, inspections, education, measurements, etc.

Furthermore, accreditation may be required and implemented by a computerized certification system, e.g., overseen by a regulatory body, which controls deployment of the resources. In some cases, numerous providers or vendors may be involved in the accreditation process, resulting in manual processes that can delay deployment of such critical resources.

### SUMMARY

Aspects of the disclosure provide a QR (quick response) code-based technology platform for accrediting critical resources for certification and deployment.

A first aspect provides a system that includes: a memory; and a processor coupled to the memory and configured to generate and deploy real-time accreditation records for a resource according to process that includes: transmitting a QR code to a provider of a certification event, wherein the QR code encodes an event ID of the certification event; receiving a completion token from an accreditation App, wherein the completion token includes resource details stored on the App and the event ID obtained by scanning the QR code; obtaining certification event details based on the event ID; generating a real-time record for the resource, wherein the real-time record includes the resource details and the certification event details; and uploading the real-time record to an accreditation database, wherein the real-time record is made immediately available for deployment to a resource certification system.

A second aspect provides a method of generating and deploying real-time accreditation records for a resource. The method includes: transmitting a QR code to a provider of a certification event, wherein the QR code encodes an event ID of the certification event; receiving a completion token from an accreditation App, wherein the completion token includes resource details stored on the App and the event ID obtained by scanning the QR code; obtaining certification event details based on the event ID; generating a real-time record for the resource, wherein the real-time record includes the resource details and the certification event details; and uploading the real-time record to an accreditation database, wherein the real-time record is made immediately available for deployment to a resource certification system.

A third aspect provides a technology platform that provides real-time accreditation for resources. The platform includes: an App configured to run on a mobile device, wherein the mobile device includes a camera and wherein the App includes a user interface configure to: store resource details for a resource; view certification events available from a set of providers; view accreditation data for the resource; and cause the camera to scan a QR code and generate a completion token, wherein the completion token includes resource details and the event ID obtained by scanning the QR code; and a server having a memory and a processor coupled to the memory and configured to: provide QR codes to providers of certification events, wherein each QR code encodes an event ID of an associated certification event; receive the completion token from the App; obtain certification event details based on the event ID in the completion token; generate a real-time record for the resource, wherein the real-time record includes the resource details and the certification event details; and upload the real-time record to an accreditation database, wherein the real-time record is made immediately available for deployment to a resource certification system.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a real-time accreditation platform according to embodiments.

FIG. 2 shows an accreditation App and record generation system according to embodiments.

FIG. 3 shows an event management system according to embodiments.

FIG. 4 shows flow diagram of a real-time accreditation process according to embodiments.

FIG. 5 depicts a network, according to embodiments.

FIG. 6 depicts a computer system, according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Various embodiments provided herein relate to a computerized platform for accrediting critical resources for certification and deployment. These embodiments address technical shortcomings in existing systems that rely on manual processes, which can significantly delay deployment. A technical solution is provided that generates real-time records based on QR codes when accreditation events are completed. The real-time records can be immediately accessed from a centralized database via an information gateway.

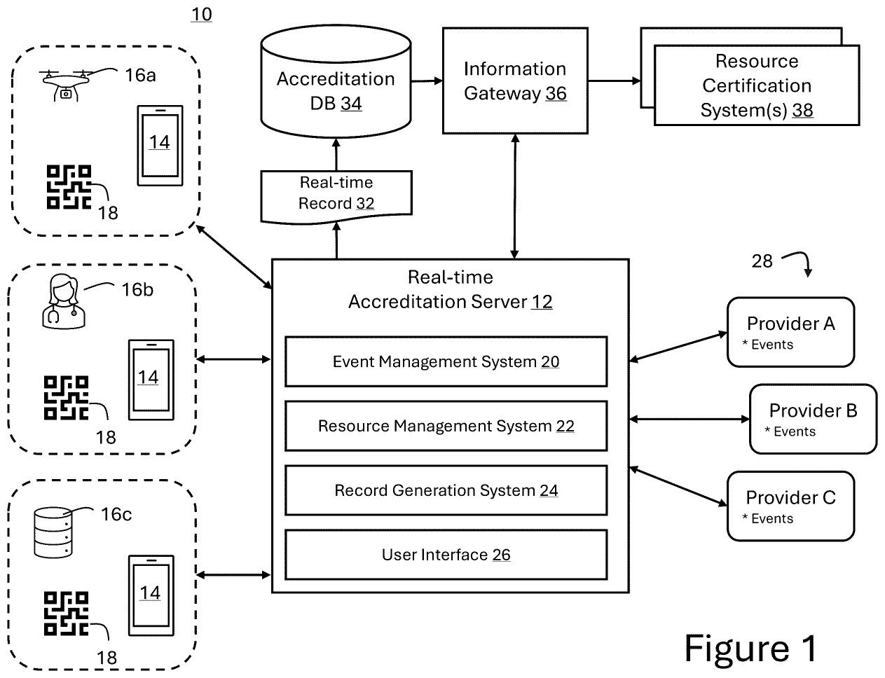

FIG. 1 depicts an overview of an illustrative technology platform 10 that generally includes a real-time accreditation server 12, an accreditation App 14, an accreditation database (DB) 34, and an information gateway 36. Platform 10 provides an infrastructure within which critical resources 16a, 16b, 16c can be immediately accredited when a certification event is completed. As noted, critical resources may include any type of resource from any domain in which there is some risk associated with the resources that require periodic certification before they can be deployed. In the example domains shown, critical resources include autonomous vehicles (e.g., drones) 16a, people (e.g., emergency medical technicians (EMTs)) 16b, and artificial intelligence models 16c. Other illustrative domains may for example comprise equipment, machines, computing systems, etc. Platform 10 would typically be implemented for a specific domain.

Certification events are provided by event providers 28 (e.g., Providers A, B, C), and may for example comprise tests, training, inspections, education, measurements, etc., and may be delivered in any form, e.g., computer programs, audio/video (AV) broadcasts, interactive media, augmented reality systems, in-person events, etc. Event providers 28 may comprise any type of system or entity, e.g., a computer program, a computer network, an AV platform, a robot, a person, etc. In a typical domain, there may be any number of event providers 28 that provide any number of certification events. For example, Provider A may provide a first type or series of certification events while Provider B may provide a second type or series of certification events. Resources 16a, 16b, 16c may be required to complete a certain number or type of events for certification, which can be provided by one or more providers 28. Event management system 20 manages the information for all events and providers. For example, event providers 28 can register with the server 12 via user interface 26 and upload their certification events available for resources 16a, 16b, 16c. Certification events and/or providers may also require approval by the event management system 20 before events can be provisioned by the provider. Approval can be done in any manner.

App users (e.g., individuals responsible for resources 16a, c or individuals that are themselves the resources such as EMTs 16b) can interact with App 14 and register with server 12 via resource management system 22. Resource management system 22 accordingly provides certification information about all registered users. Users can also search the event management system 20 to identify and/or sign-up for certification events from providers 28, e.g., via a user interface 26.

When the certification event is approved for provisioning or when an event is provisioned by a provider, server 12 generates a QR code 18 for the provider's event. The provider can then display the QR code to a resource when the resource completes the event. The QR code can be displayed by the provider via any display technology or directly through the App 14. Once displayed, user can scan the QR code 18 using the App/camera of the mobile device, which triggers information to be transmitted from the App back to record generation system 24 at server 12. Once the information is received at the server 12, the record generation system 24 generates a real-time record indicating that the certification event was completed for the resource 16a, 16b, 16c. Real-time records 32 can for example be generated in less than second. Once generated, the real-time record 32 is immediately loaded to accreditation database 34 for deployment, where a resource certification system 38 can then immediately access the record from the accreditation database 34 via information gateway 36 (e.g., using a Simple Object Access Protocol (SOAP) call). Resources 16a, 16b, 16c can accordingly be instantly certified and deployed by the resource certification system 38, avoiding any delays.

As noted, certification events can for example include test events, training events, inspection events, education events, measurement events, etc. Test events can for example include electrical or mechanical tests, e.g., testing switches, reliability, stress tests, etc., as well as written tests. Training events can for example include training of an AI model, computer training, A/V presentations, etc. Inspection events can for example include robotic inspections of equipment, field testing of equipment to ensure compliance requirements, etc. Education events can for example include continuing education, A/V presentations, live presentations, classroom training, etc. Measurement events can for example include robotic measurements, sound measurements, size measurements of components, wear and tear, etc. The type of certification events being provisioned will largely depend on the domain within which technology platform 10 is utilized and are not intended to be limited to any particular technology or deployment process.

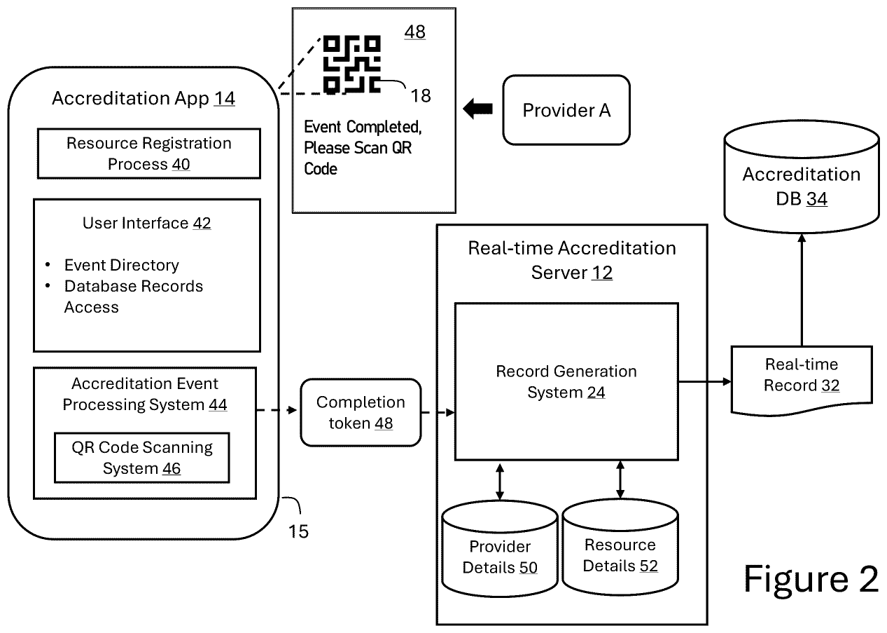

FIG. 2 depicts a further overview of the accreditation App 14 (e.g., running on a mobile device 15) and record generation system 24 (running on real-time accreditation server 12). Accreditation App 14 includes a resource registration process 40 for registering a resource (e.g., username and password creation, etc.) and a user interface 42 that, e.g., allows a user to view and search an event directory of available certification events and allows the user to view information associated with the resource such as existing records, certifications, licenses, etc. App 14 also includes an accreditation event processing system 44, which allows the user to sign up for a certification event and obtain real-time accreditation upon completion of the event. In the illustrative embodiment, certification event 48 is created and provisioned by Provider A. Upon completion of the event 48 by resource 16b, Provider A displays QR code 18, e.g., on a video screen, in print, within the App 14, in a different App, etc. QR code scanning system 46 is then utilized to instruct a camera on the mobile device 15 to scan the QR code 18, which in turn generates a completion token 48 that is transmitted to record generation system 24 in real-time accreditation server 12.

Completion token 48 may for example include an encrypted data packet containing: (1) resource details, e.g., the username and password for the resource obtained from the accreditation App, and (2) an event ID encoded in the QR code 18 identifying the completed event. Once the token is received at server 12, the token 48 is decrypted and the resource is logged into server 12 with the username and password. The record generation system 24 then builds the real-time record 32 for the resource using the event ID, provider details 50 (e.g., details about the event), and resource details 52 (e.g., details about the resource). The real-time record 32 is then immediately uploaded to the accreditation database 34.

Real-time record 32 may for example be generated as follows for a resource that comprises an autonomous vehicle 16a:
<Resource ID> Vehicle XYZ
   <Event Type> Safety Inspection
   <Provider ID> Provider A
      <Event ID> Event_123
      <Event Topic> Collision Avoidance
      <Event Date> Dec. 10, 2024
      <Expiration> Dec. 10, 2025

Real-time record 32 may for example be generated as follows for a resource 16b that comprises an individual:
<Resource ID> Jane Smith
   <Event Type> Operational Safety License
   <Provider ID> Provider A
      <Event ID> Event_123
      <Event Topic> Security Assessments
      <Event Date> Dec. 10, 2024
      <Expiration> Dec. 10, 2025

Real-time record 32 may for example be generated as follows for a resource 16c that comprises an artificial intelligence model:
<Resource ID> AI model ABC
   <Event Type> Counter Fraud
   <Provider ID> Provider A
      <Event ID> Event_123
      <Event Topic> Fraud Model Training
      <Event Date> Dec. 10, 2024
      <Expiration> Dec. 10, 2025

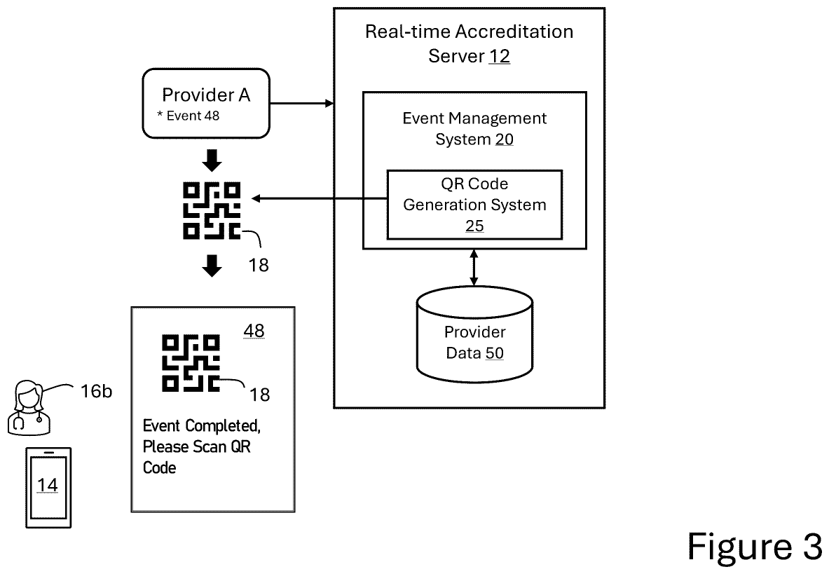

FIG. 3 depicts an overview of the event management system 24 that runs on real-time accreditation server 12. Initially, each provider (i.e., Provider A) interfaces with event management system 20 to upload event information which is stored as provider details 50 on the server. For example, each event may include an event ID, event name, event topic, dates, etc. When the provider (e.g., Provider A) provisions the event to a resource 16b (or, e.g., when the event details are uploaded to event management system 24), QR code generation system 25 generates a QR code 18 that encodes event details, e.g., event ID, etc. When the provider is done provisioning the event for one or more resources that successfully complete the event, the QR code 18 is displayed by the provider, which can then be scanned by the App 14. QR codes can be generated in any manner, e.g., using any commercially available QR generator.

As noted, in various embodiments, resources can be individuals such as EMTs needing certification to perform critical functions. In such cases, certification events may for example comprise continuing education courses, training, etc., necessary to be licensed in or more states. The resource certification system(s) 38 (FIG. 1) in those cases may comprise computer implemented systems, such as web-based software as a service (SaaS) platform implemented by regulatory bodies such as national registry entities, etc., that are responsible for certification and recertification of the individuals. In such cases, the real-time records 32 may include course completion records that get generated in real-time and are made immediately available on such platforms for the regulatory bodies. Information gateway 36 may for example comprise an application programming interface (API) that facilitates the process of exchanging data between the accreditation database 34 and resource certification system 38.

As noted, in other embodiments, resources can be non-human entities needing certification to perform critical functions such as autonomous vehicles (e.g., drones) or AI models. In such cases, certification events may for example comprise safety inspections, training, measurements, testing, etc., necessary to, e.g., be licensed in or more states. The resource certification system(s) 38 (FIG. 1) in those cases may likewise be implemented by regulatory bodies such as national registry entities, etc., that are responsible for certification and recertification of the resources. In such cases, the real-time records 32 may include testing or training records that get generated in real-time and are made immediately available to systems implemented by the regulatory bodies.

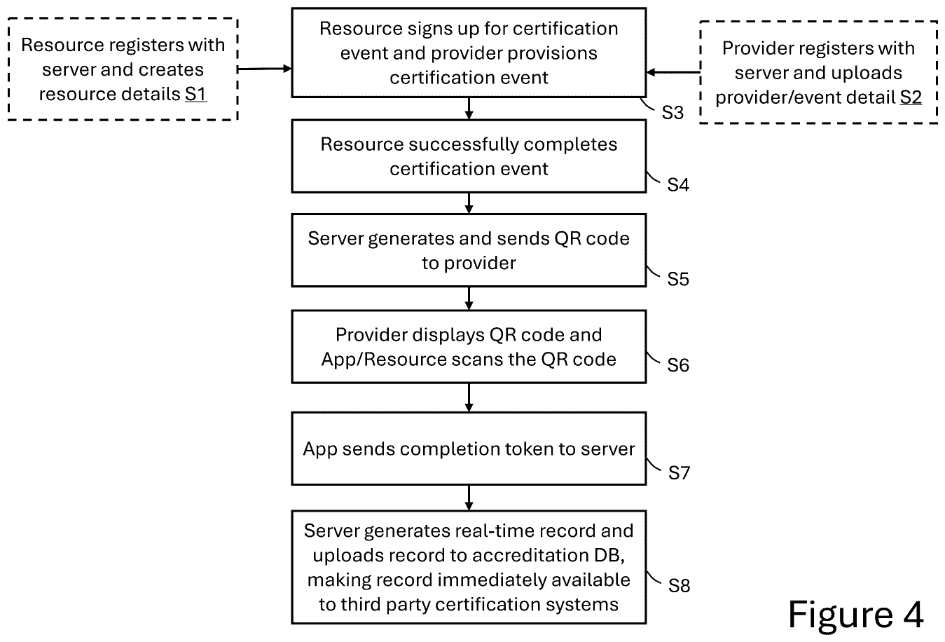

FIG. 4 depicts a flow diagram of an illustrative real-time QR code based accreditation method. Preliminarily, at S1, a resource registers with the real-time accreditation server 12 and creates resource details, including a username and password. Likewise, at S2, a provider registers with the server 12 and uploads provider details, which includes certification events offered by the provider. At S3, a resource signs up for a certification event and the provider provisions the event. At S4, the resource successfully completes the certification event, and at S5 the server 12 generates and sends a QR code to the provider, which includes encoded details of the certification event. At S6, the provider displays the QR code, then the mobile device camera/App 14 associated with the resource scans the QR code. The App generates a completion token, which is forwarded to the server 12 at S7, and at S8, the server generates a real-time record and uploads the record to the accreditation database, making the record immediately available to third party certification systems.

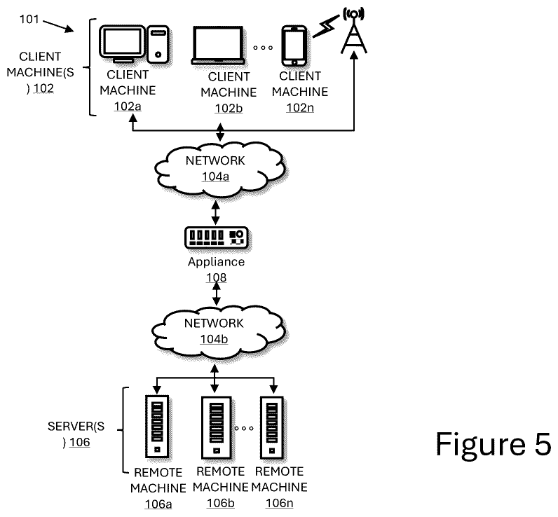

It is understood that aspects of the described infrastructure can be implemented in any manner, e.g., as a stand-alone system, a distributed system, within a network environment, etc. Referring to FIG. 5, a non-limiting network environment 101 in which various aspects of the disclosure may be implemented includes one or more client machines 102A-102N, one or more remote machines 106A-106N, one or more networks 104, 104′, and one or more appliances 108 installed within the computing environment 101. The client machines 102A-102N communicate with the remote machines 106A-106N via the networks 104, 104′.

In some embodiments, the client machines 102A-102N communicate with the remote machines 106A-106N via an intermediary appliance 108. The illustrated appliance 108 is positioned between the networks 104, 104′ and may also be referred to as a network interface or gateway. In some embodiments, the appliance 108 may operate as an application delivery controller (ADC) to provide clients with access to business applications and other data deployed in a datacenter, the cloud, or delivered as Software as a Service (SaaS) across a range of client devices, and/or provide other functionality such as load balancing, etc. In some embodiments, multiple appliances 108 may be used, and the appliance(s) 108 may be deployed as part of the network 104 and/or 104′.

The client machines 102A-102N may be generally referred to as client machines 102, local machines 102, clients 102, client nodes 102, client computers 102, client devices 102, computing devices 102, endpoints 102, or endpoint nodes 102. The remote machines 106A-106N may be generally referred to as servers 106 or a server farm 106. In some embodiments, a client device 102 may have the capacity to function as both a client node seeking access to resources provided by a server 106 and as a server 106 providing access to hosted resources for other client devices 102A-102N. The networks 104, 104′ may be generally referred to as a network 104. The networks 104 may be configured in any combination of wired and wireless networks.

A server 106 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 106 may execute a remote presentation services program or other program that uses a thin-client or a remote-display protocol to capture display output generated by an application executing on a server 106 and transmit the application display output to a client device 102.

In yet other embodiments, a server 106 may execute a virtual machine providing, to a user of a client device 102, access to a computing environment. The client device 102 may be a virtual machine. The virtual machine may be managed by, for example, a hypervisor, a virtual machine manager (VMM), or any other hardware virtualization technique within the server 106.

In some embodiments, the network 104 may be: a local-area network (LAN); a metropolitan area network (MAN); a wide area network (WAN); a primary public network 104; and a primary private network 104. Additional embodiments may include a network 104 of mobile telephone networks that use various protocols to communicate among mobile devices. For short range communications within a wireless local-area network (WLAN), the protocols may include 802.11, Bluetooth, and Near Field Communication (NFC).

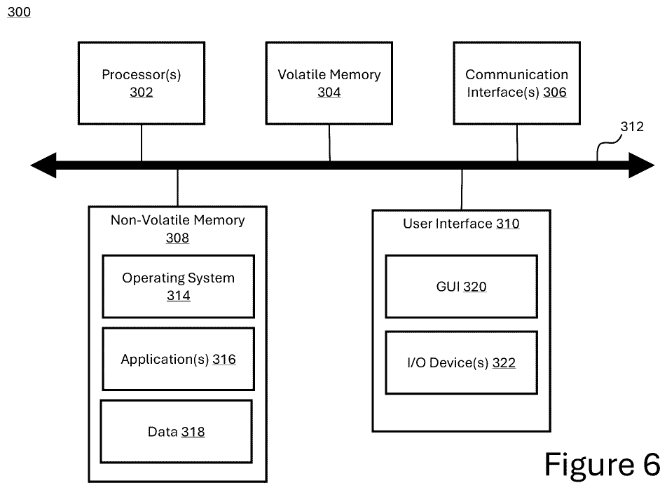

Elements of the described solution may be embodied in a computing system, such as that shown in FIG. 6 in which a computing device 300 may include one or more processors 302, volatile memory 304 (e.g., RAM), non-volatile memory 308 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 310, one or more communications interfaces 306, and communication bus 312. User interface 310 may include graphical user interface (GUI) 320 (e.g., a touchscreen, a display, etc.) and one or more input/output (I/O) devices 322 (e.g., a mouse, a keyboard, etc.). Non-volatile memory 308 stores operating system 314, one or more applications 316, and data 318 such that, for example, computer instructions of operating system 314 and/or applications 316 are executed by processor(s) 302 out of volatile memory 304. Data may be entered using an input device of GUI 320 or received from I/O device(s) 322. Various elements of computer 300 may communicate via communication bus 312. Computer 300 is shown merely as an example, as clients, servers and/or appliances and may be implemented by any computing or processing environment and with any type of machine or set of machines that may have suitable hardware and/or software capable of operating as described herein.

Processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 306 may include one or more interfaces to enable computer 300 to access a computer network such as a LAN, a WAN, or the Internet through a variety of wired and/or wireless or cellular connections.

In described embodiments, a first computing device 300 may execute an application on behalf of a user of a client computing device (e.g., a client), may execute a virtual machine, which provides an execution session within which applications execute on behalf of a user or a client computing device (e.g., a client), such as a hosted desktop session, may execute a terminal services session to provide a hosted desktop environment, or may provide access to a computing environment including one or more of: one or more applications, one or more desktop applications, and one or more desktop sessions in which one or more applications may execute.

As will be appreciated by one of skill in the art upon reading the following disclosure, various aspects described herein may be embodied as a system, a device, a method or a computer program product (e.g., a non-transitory computer-readable medium having computer executable instruction for performing the noted operations or steps). Accordingly, those aspects may take the form of an entirely hardware embodiment, an entirely software embodiment, or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

What is claimed is:

1. A system, comprising:
a memory; and
a processor coupled to the memory and configured to generate and deploy real-time accreditation records for a resource according to process that includes:
transmitting a QR code to a provider of a certification event, wherein the QR code encodes an event ID of the certification event;
receiving a completion token from an accreditation App, wherein the completion token includes resource details stored by the accreditation App and the event ID obtained by scanning the QR code;
obtaining certification event details based on the event ID;
generating a real-time record for the resource, wherein the real-time record includes the resource details and the certification event details; and
uploading the real-time record to an accreditation database, wherein the real-time record is made immediately available for deployment to a resource certification system.

2. The system of claim 1, wherein the completion token is encrypted.

3. The system of claim 1, wherein the certification event comprises one of an inspection event, a training event, a testing event, an educational event or a measurement event.

4. The system of claim 1, wherein the resource comprises one of a system, an autonomous vehicle, an artificial intelligence model, a piece of equipment, or a person.

5. The system of claim 1, wherein the resource details comprise a name and password associated with the resource.

6. The system of claim 1, wherein the certification event details comprise an event name, an event topic and an event type.

7. A method of generating and deploying real-time accreditation records for a resource, the method comprising:
transmitting a QR code to a provider of a certification event, wherein the QR code encodes an event ID of the certification event;
receiving a completion token from an accreditation App, wherein the completion token includes resource details stored by the accreditation App and the event ID obtained by scanning the QR code;
obtaining certification event details based on the event ID;
generating a real-time record for the resource, wherein the real-time record includes the resource details and the certification event details; and
uploading the real-time record to an accreditation database, wherein the real-time record is made immediately available for deployment to a resource certification system.

8. The method of claim 7, wherein the completion token is encrypted.

9. The method of claim 7, wherein the certification event comprises one of an inspection event, a training event, a testing event, an educational event or a measurement event.

10. The method of claim 7, wherein the resource comprises one of a system, an autonomous vehicle, an artificial intelligence model, a piece of equipment, or a person.

11. The method of claim 7, wherein the resource details comprise a name and password associated with the resource.

12. The method of claim 7, wherein the certification event details comprise an event name, an event topic and an event type.

13. A technology platform that provides real-time accreditation for resources, comprising:
an App configured to run on a mobile device, wherein the mobile device includes a camera and wherein the App includes a user interface configure to:
store resource details for a resource;
view certification events available from a set of providers;
view accreditation data for the resource; and
cause the camera to scan a QR code and generate a completion token, wherein the completion token includes resource details and an event ID obtained by scanning the QR code; and
a server having a memory and a processor coupled to the memory and configured to:
provide QR codes to providers of certification events, wherein each QR code encodes an event ID of an associated certification event;
receive the completion token from the App;
obtain certification event details based on the event ID in the completion token;
generate a real-time record for the resource, wherein the real-time record includes the resource details and the certification event details; and
upload the real-time record to an accreditation database, wherein the real-time record is made immediately available for deployment to a resource certification system.

14. The technology platform of claim 13, wherein the completion token is encrypted.

15. The technology platform of claim 13, wherein each certification event comprises one of an inspection event, a training event, a testing event, an educational event or a measurement event.

16. The technology platform of claim 13, wherein the resource comprises one of a system, an autonomous vehicle, an artificial intelligence model, a piece of equipment, or a person.

17. The technology platform of claim 13, wherein the resource details comprise a name and password associated with the resource.

18. The technology platform of claim 13, wherein the certification event details comprise an event name, an event topic and an event type.
